(19) United States
(12) Patent Application Publication
(10) Pub. No.: US 2008/0131327 A1
(43) Pub. Date: Jun. 5, 2008

(54) SYSTEM AND METHOD FOR INTERFACING WITH A MICROFLUIDIC CHIP

(75) Inventors: Robert Michael VAN DAM, Glendale, CA (US); Arkadij ELIZAROV, Valley Village, CA (US); James R. HEATH, South Pasadena, CA (US)

Correspondence Address: LADAS & PARRY, 5670 WILSHIRE BOULEVARD, SUITE 2100, LOS ANGELES, CA, 90036-5679, US

(73) Assignee: CALIFORNIA INSTITUTE OF TECHNOLOGY, Pasadena, CA (US)

(21) Appl. No.: 11/862,127

(22) Filed: Sep. 26, 2007

Related U.S. Application Data
(60) Provisional application No. 60/847,993, filed on Sep. 28, 2006.

(51) Int. Cl. B01L 11/00; B29C 65/00; B32B 38/00

(52) U.S. Cl. 422/103; 156/281; 156/242

(57) ABSTRACT

An interface system and device for interfacing a microfluidic chip system is disclosed comprising an adapter having channels and ports connecting to the microfluidic chip system and an external fluidic system. An interface, device and method are provided herein, that disclose the connection of larger volumes of an external fluidic system to smaller volumes of a microfluidic chip system and the ability to effectively purge microfluidic channels without contamination.

### CROSS REFERENCE TO RELATED APPLICATIONS

This application claims priority to U.S. Provisional Ser. No. 60/847,993 for “Methods and Devices for Interfacing with a Microfluidic Chip” filed on Sep. 28, 2006 all of which is incorporated herein by reference in its entirety.

### STATEMENT OF GOVERNMENT SUPPORT

The present invention was made with support from the United States Government under Grant No. CA119347 awarded by the National Cancer Institute at Frederick. The United States Government has certain rights in the invention.

### BACKGROUND

1. Field

The present disclosure relates to the interfacing of an external system with a microfluidic device. In particular, an apparatus and method are disclosed wherein fluid from an external system is effectively provided to a microfluidic chip device by way of an adapter. More specifically, an interface system and method for interfacing with a microfluidic chip are disclosed.

2. Description of Related Art

Microfluidic systems typically manipulate fluid volumes in the range of nL (nanoliters) to uL (microliters), whereas conventional fluid handling equipment typically uses volumes in the range of tens of uL (microliters) to mL (milliliters) or more. This volume mismatch must be addressed when integrating a microfluidic system with an external fluidic system. Despite much progress in the field of microfluidics over the past several years, there have been no reported systems that address this world-to-chip interface problem in a general way.

The volume mismatch has been addressed in the literature for a few specialized applications. For example, a large sample in the external fluidic system can be divided up among a large number of channels or chambers in a microfluidic chip (Liu, J et al., 2003, Anal Chem., 75: 4718-4723). This approach is suitable in applications where reagents are provided in a combinatorial manner or where a sample is analyzed in a combinatorial fashion, but is not useful for microfluidic chips that perform a small number of arbitrary syntheses and analyses. A number of companies have technologies based on this concept (e.g. Caliper Life Sciences “Sipper Chip™”).

While such technologies and other ultra-low dead-volume connectors make efficient use of reagents in microfluidic chips, they do not address the general problems of elimination of trapped air when delivering fluids to the microfluidic chip, and cleaning and drying of fluid lines. From the microfluidic chip perspective, these processes involve “huge” volumes of air or fluids that need to be eliminated or passed through the chip.

Another limitation of reported microfluidic systems and technologies is that connections to external fluidic systems are impractical for commercial applications that involve frequent and repeated removal and assembly of microfluidic chips. It is believed that a vast range of microfluidic applications will one day use disposable or recyclable microfluidic chips. With this perspective, what is needed is a technology that allows rapid swapping (change-in/change-out) of microfluidic chips.

In reported connection technologies, external tubing/needles/pipette-tips are slipped or glued onto posts integrated into the microfluidic chip, or is inserted into built-in ports, held in place by glue or compression fittings. Glued and other permanent forms of connections are clearly not suitable in applications where swapping must occur. Removable connections such as slip-on fittings or threaded fittings are superior, but removal and installation of the microfluidic chip can take considerable time if there are more than a couple of fittings. In addition, manual attachment of numerous fittings introduces a significant possibility of error.

Some notable exceptions to these shortcomings exist. For example, Fluidigm Corp. has developed a carrier system wherein a PDMS (poly-dimethylsiloxane) microfluidic chip is sealed or bonded to a plastic cartridge, that is designed to be easily swappable in an instrument (See, for example, US 2005/0214173A1 “Integrated Chip Carriers with Thermocycler Interfaces and Methods of Using the Same”.) The present disclosure allows for rapid swapping of microfluidic chips without the need for a carrier/cartridge system—i.e. the microfluidic chip itself is directly swapped. The ability to swap only the microfluidic chip has the potential to dramatically reduce the complexity and cost of replaceable microfluidic devices.

In many instances when a microfluidic device is interfaced with an external fluidic system, there is a need to purge trapped air from reagent lines between reagent sources in the external system and input channels within the microfluidic chip. Delivery of reagents to the chip involves the operations of first purging the air, and then introducing the reagent.

In some applications, a “vent” port in the microfluidic channel could be opened to allow most of the air to escape. However, the use of such an open port provides the risk that the sample could be lost due to inaccuracies in flow rates, pressures, etc in the system. If the sample is valuable, it is preferable to deliver it through a single channel into a closed reactor that does not have a vent adjacent to the reactor area. If the microfluidic chip is made from a permeable material such as PDMS, any trapped air can be forced into the bulk polymer. If the microfluidic chip contains a gas-exchange membrane, the trapped air can similarly be forced through the membrane. However, depending on permeability and pressure, this can take a significant amount of time and slow down the microfluidic process. Another situation where such a “vent” port is impractical is if a reactor portion of the microfluidic chip is filled with some intermediate compound. To add a new reagent, it is desirable to fill from a single channel to avoid flushing out some of the intermediate while introducing the new reagent.

Combined with the features mentioned above, what is needed in the art is an interface system for effectively and expediently facilitating the connection of microfluidic systems to external fluidic system in a wide range of applications.

### SUMMARY

In a first aspect of the present disclosure, an interface system for interfacing a microfluidic chip system with an external system is disclosed, comprising: an adapter; at least one adapter channel having two ends within said adapter, and at least two adapter ports within said adapter, defined by a first and second opening at each end of the at least one adapter channel; a microfluidic chip system comprising: at least one microfluidic port; at least one microfluidic channel, and at least one microfluidic valve, wherein the adapter seals to the microfluidic chip system forming an interface at which the first opening of the at least two adapter ports connects to the at least one microfluidic port, and wherein the adapter is adapted to affix to the external system through connection of the second opening of the at least two adapter ports to the external system.

In a second aspect of the present disclosure, a device for interfacing a microfluidic chip system with an external system is disclosed, comprising: an adapter; at least one adapter channel located within said adapter having two ends, and at least two adapter ports located within said adapter, defined by a first and second opening at each end of the at least one adapter channel, wherein the adapter seals to the microfluidic chip system forming an interface at which the first opening of the at least two adapter ports connects to the microfluidic chip system, and wherein the adapter is adapted to affix to the external system through connection of the second opening of the at least two adapter ports to the external system.

In a third aspect of the present disclosure, a method of making an interface system for interfacing a microfluidic chip system with an external fluidic system is disclosed, comprising: providing an adapter having at least a first surface and a second surface; forming at least one adapter channel having two ends within said adapter; forming at least two adapter ports within said adapter to have a first and second opening at each end of the at least one adapter channel; providing the microfluidic chip system comprising at least one microfluidic port; at least one microfluidic channel, and at least one microfluidic valve; sealing the adapter to the microfluidic chip system to form an interface; connecting the first opening of the at least two adapter ports to the at least one microfluidic port; affixing the adapter to the external fluidic system by connecting the second opening of the at least two adapter ports to at least one external system port.

In a fourth aspect of the present disclosure, a method of making a device for interfacing a microfluidic chip system with an external system is disclosed, comprising: providing an adapter having at least a first surface and a second surface; forming at least one adapter channel having two ends within said adapter; forming at least two adapter ports within said adapter to have a first and second opening at each end of the at least one adapter channel; sealing the adapter to the microfluidic chip system to form an interface; affixing the adapter to the external system by connecting the second opening of the at least two adapter ports to the external system.

The present disclosure provides methods and devices for interfacing microfluidic chip systems with external fluidic systems. The interface described comprises primarily an “adapter”. The adapter has a simple design that can easily be manufactured from a variety of materials (e.g. plastics, metals, etc), to be chosen depending on the application and the particular fluids/gases to be used in the microfluidic chip system.

### BRIEF DESCRIPTION OF THE DRAWINGS

FIG. 1 shows a detailed cross-sectional view of the interface between a microfluidic chip system (50) and an adapter (40) with one adapter channel (10).

FIG. 2A is a cross-sectional view showing the interface (48) of a microfluidic chip system (50) and an adapter (40) with a junction point (15) of a bypass channel (30) located within the adapter (40). FIG. 2B is a further cross-sectional view showing the junction point (15) of a bypass channel (30) located within the microfluidic chip system (50).

FIG. 3A shows a top view schematic of a microfluidic valve (80), a bypass channel (30) and a junction point (15) within the microfluidic chip. FIG. 3B shows a section view along the dotted A-A of FIG. 3A.

FIG. 4 shows a CAD model of a microfluidic chip (50) and adapter (40) wherein the bypass channels (30) are within the adapter.

FIG. 5 shows a CAD model of a microfluidic chip (50) and adapter (40) wherein the bypass junctions (30) are within the microfluidic chip.

FIG. 6 shows a CAD model of adapter (40) with microfluidic chip (50) installed and force applied to a substrate (140) to hold the microfluidic chip and adapter in a sealed interface.

FIG. 7 shows a partial process diagram for FDG (2-deoxy-2-[¹⁸F]fluoro-D-glucose) synthesis with a microfluidic chip system, illustrating the sharing of a waste port (130) from several bypass channels (30) within a microfluidic chip (50).

### DETAILED DESCRIPTION

An adapter device for interfacing a microfluidic chip system with an external fluidic system according to the present disclosure, comprises an adapter between components of the external fluidic system and the microfluidic chip system. The adapter seals to the microfluidic chip to make fluid-tight connections between ports on the microfluidic chip and corresponding ports on the adapter. The adapter contains a number of internal “channels”. For each such channel, one of the two openings of the channel corresponds to a port on the microfluidic chip, while the other opening is configured to connect to the external fluidic system via tubing, threaded fittings, etc. Each adapter channel will carry fluids such as samples, reagents, wash solvents, or gases to the microfluidic chip (i.e. the inputs to the microfluidic process), and/or fluids such as synthesized product or waste from the microfluidic chip (i.e. the outputs of the microfluidic process). It should be appreciated that some adapter channels may be manifolds and connect many ports of the microfluidic chip to a single part of the external system or vice versa. The “adapter channels” may pass straight through the adapter for simplicity and ease of manufacture, or they may contain bends to allow ports to exit the sides of the adapter to provide more space for fluidic connectors or to provide for more flexible routing possibilities. Thus, it should be understood that the layout and configuration of the adapter channels and adapter ports can vary widely in an adapter just as it is known they vary in a microfluidic chip. Disclosures relating to the fabrication and assembly of microfluidic chips include U.S. Pat. No. 7,040,338, and U.S. application Ser. Nos. 11/297,651; 11/514,396, and 11/701,917, all of which are incorporated by reference herein in their entirety.

Herein the terms “microfluidic chip”, “microfluidic chip system”, “chip”, “microfluidic device” can all be used interchangeably without significantly changing the context of the disclosure. The “microfluidic chip system” refers to the microfluidic chip and all components going into and out of the chip, whereas “chip” and “microfluidic chip” both refer to the microfluidic chip alone. A “microfluidic device” can refer to any device having microfluidic properties.

Herein the term “adapter” refers to the device and all of its internal channels, ports, valves, etc separate from the microfluidic chip system. The “interface system” refers to the microfluidic chip system, the adapter together with an external system. The “external system” is also referred to as an “external fluidic system”.

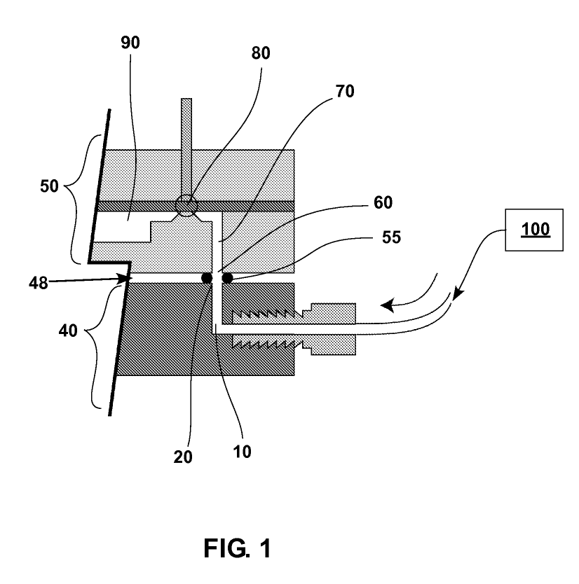

An interface system comprising an adapter according to the present disclosure is shown in FIG. 1. FIG. 1 shows an adapter (40) in a position below the microfluidic chip (50) wherein the adapter channel (10) flows up through the adapter to the microfluidic port (60) leading to the microfluidic channel (70) within which fluid flow is regulated by the microvalve (80) opening to the reaction area (90). The interface between the adapter channel (10) and the microfluidic port (60) is sealed in this example with an O-ring (55). The point on the adapter at which the adapter channel passes out of the adapter is the adapter port (20) which connects with a “cognate” microfluidic chip port (60).

It is common in the present art that a microfluidic chip has tubing connected directly from an external system to an input port on the microfluidic chip. In FIG. 1, the microfluidic chip receives fluid directly from the adapter channel (10) to the microfluidic channel (70). At present, for the installation of a new microfluidic chip starting from a dry system, there is no known method to eliminate trapped air other than forcing it through the microfluidic channel. In many applications this is not practical. For example, it may not be desirable to introduce air bubbles into the system as they could interfere with flow patterns and accurate measurement of volumes.

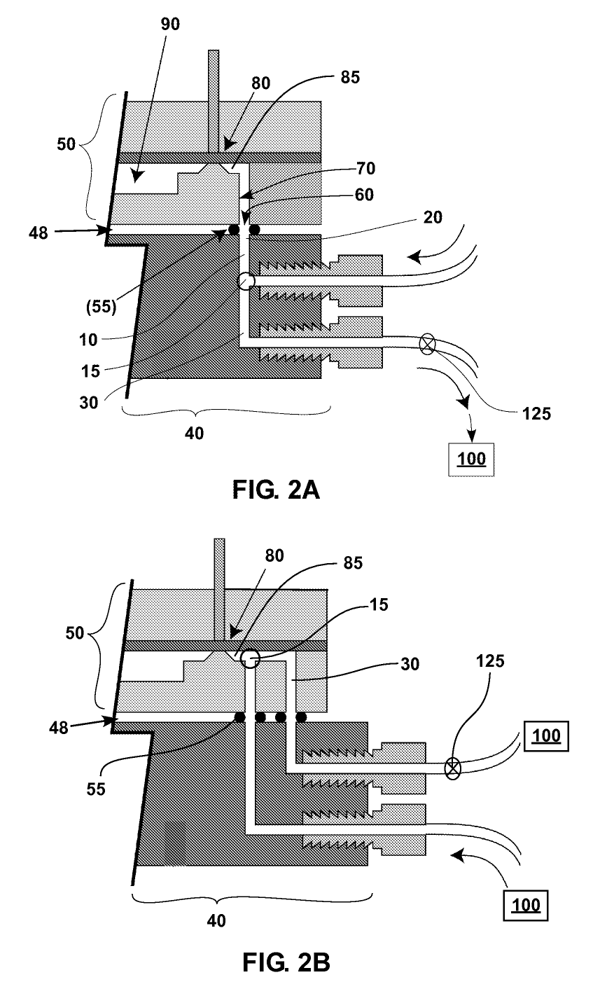

An adapter (40) according to the present disclosure, further comprising a bypass channel (30), as shown in FIGS. 2A-2B, addresses the problems associated with introducing air bubbles into the microfluidic chip system as well as other “channel flushing” issues. When the microfluidic valve (80) is closed, the air at junction point (15) is forced down away from the microfluidic valve and out through the bypass channel (30). After “bleeding” out the air, the exit port can be blocked, e.g. by a downstream bypass valve (125) which can be either a part of the adapter or a part of the external fluidic system (100).

FIG. 2A shows a bypass channel (30) located within the adapter (40). FIG. 2A shows that when the microfluidic valve (80) is actuated and the microfluidic channel (70) is thus closed, and the bypass valve (125) is open, the fluid in the adapter channel (10) at a junction point (15) will be forced out through the bypass channel (30). FIG. 2B shows a bypass channel (30) located within the microfluidic chip system (50). FIG. 2B shows that when the microfluidic valve (80) is closed and the bypass valve (125) open, the fluid entering the microfluidic channel at the junction point (15) will be forced away from the microfluidic valve (80) and through to the bypass channel (30).

A bypass channel in the adapter (FIG. 2A) or in the microfluidic chip (FIG. 2B) provides the following: a means to eliminate dead air in reagent channels and lines coming from the external fluidic system (100); a means for flushing reagent channels and lines of the external fluidic system (e.g. for reagents that are degraded by moisture, light, gases in the air or other environmental factors while sitting stagnant inside tubing, and a means to flow large amounts of wash solvents and/or air in order to clean and/or dry reagent channels of the external fluidic system. Drying the channels of the external system prevents cross-contamination in the chip-mounting area when the microfluidic chip is removed.

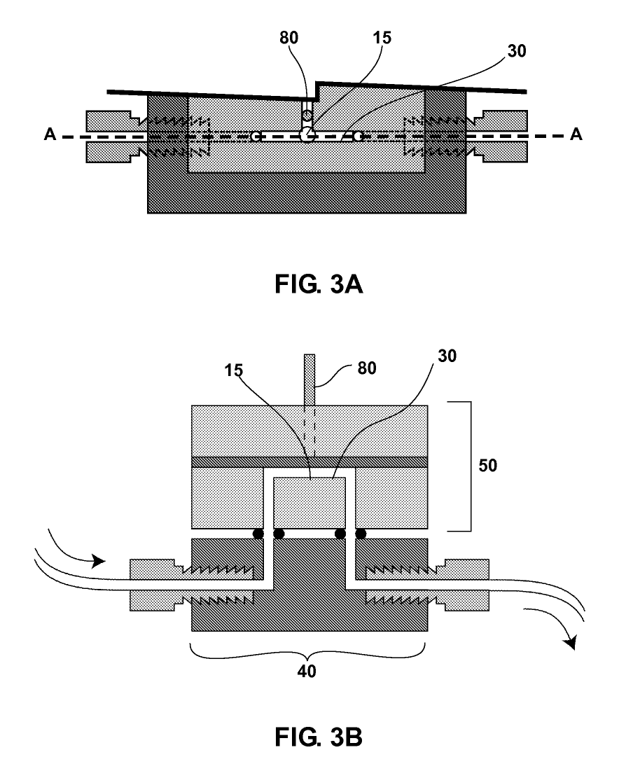

Additional views of a bypass channel (30) within the microfluidic chip system (50) are shown in FIGS. 3A (top view), 3B (sectional view). The microfluidic chip in this case requires two separate ports for a single reagent inlet in the adapter—an inlet port and an exit port. By putting the bypass junction point (15) as close as possible to the microfluidic valve (80), air volumes as low as the nanoliter range can be achieved. FIGS. 2B, 3A and 3B show a configuration of the bypass channel in the microfluidic chip (50) with the distance (85) between the microfluidic valve (80) and the junction point (15) being shorter than, for example, the distance between the microfluidic valve and the junction point in FIG. 2A where the volume can range up to a few uL. With the former configurations of FIGS. 2B, 3A, and 3B, the length and complexity of the microfluidic channels are reduced and the stagnant space (“dead volume”—air which cannot be purged) in the microfluidic chip system is minimized. As mentioned, stagnant space in the microfluidic chip system is not desired because it is difficult to wash or dry, and has the potential to create cross-contamination if several reagents are flowed into the same microfluidic channel. Furthermore, this stagnant space can lead to residual liquid in the adapter and microfluidic chip causing leakage and cross-contamination when removing the chip.

By eliminating the possibility of contamination, an adapter (40) with a bypass channel (30) according to the present disclosure, provides for a means for making a quick-release, change-in/change-out adapter device as is needed in the present art.

An alternative to the bypass junction mechanism is to have a special “dummy chip” that can be installed for perform cleaning steps. A “dummy chip” would contain relatively large channels and allow substantial flow rates through the chip to speed cleaning and drying of the adapter fluidic system. However, it should be noted that a bypass channel would still be needed to purge trapped air once the adapter and microfluidic chip system are connected. It would be obvious to one having skill in the art that a “dummy chip” could not carry out the purging of the dead volume.

In one embodiment, in order to ensure the air is purged using a bypass channel according to the present disclosure, a flow rate can be calibrated for the system for a particular reagent and flow is actuated for a fixed time to guarantee removal of all air, or a fixed volume can be purged (e.g. via syringe pump) to guarantee removal of all air. Alternatively one could use mechanical, optical, electrical, etc. means to detect when fluid has entered the adapter.

### Multiple Channel Adapter Systems

In one embodiment, the microfluidic chip has all fluidic ports (60) on one surface of the microfluidic chip and interfaces with a mating surface on the adapter having adapter ports (20) in corresponding positions. Of course it is possible that the microfluidic chip and adapter meet at several surfaces and make fluidic connections at any of these surfaces. Having all ports at a single surface may be desirable as it leaves the other surfaces available for visualization via camera/microscope, temperature control, microvalve actuation, etc, and, furthermore, fabrication/machining is most likely simpler.

An adapter according to the present disclosure provides a one-piece connection for all the ports on the microfluidic chip simultaneously to enable quick installation and removal of the microfluidic chip. The individually attached connections from an external fluidic system may remain attached to the adapter in a semi-permanent manner via threaded compression fittings/ferrules or other connectors.

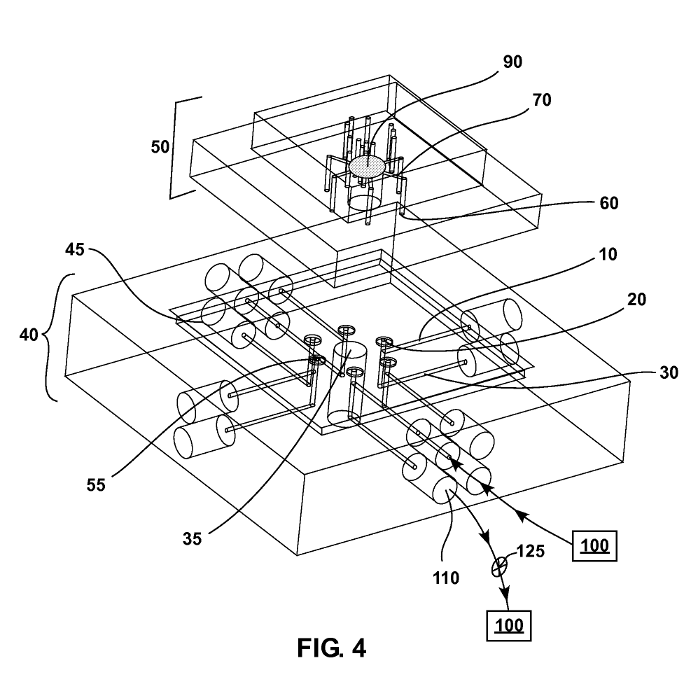

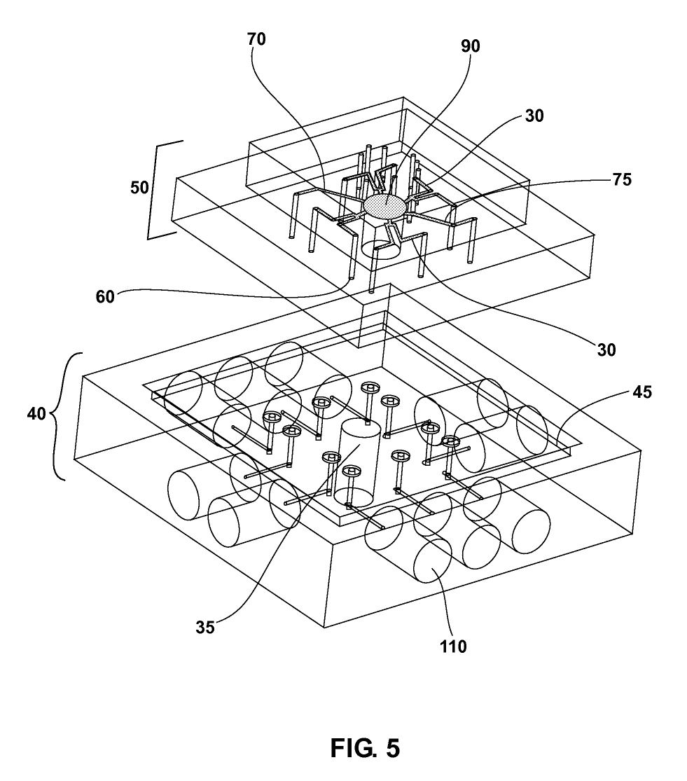

FIG. 4 shows a CAD schematic of a microfluidic chip system (50) positioned above an adapter (40), wherein the adapter and microfluidic chip have corresponding ports meeting at one interface surface (48). In FIG. 4, there are six adapter ports (20) with O-rings (55) on the chip-facing side which upon sealing connect with six microfluidic ports (60). The adapter shown in FIG. 4 has bypass channels (30) located within the adapter. In this case, the two ends of the bypass channel are two adapter-to-external ports (110) both of which connect to the external fluidic system (100) wherein one is coming from the external system and one is going to the external system. The configuration of the adapter and microfluidic chip in FIG. 4 (see also FIG. 5) allows for an open center (35). This open center allows for insertion of regulating devices such a temperature “finger” which will transfer heat or cold to the microfluidic chip. In the configuration shown, the reaction area (90) where all the microfluidic channels meet is positioned directly above the open center (35) thus facilitating the transfer of heat or cold from the temperature “finger” to the reaction area.

In one embodiment, the configuration of the adapter-to external ports (110) are on the side surfaces of the adapter (as shown in FIG. 4) to allow for other functions to occur through the top and bottom surfaces of the adapter—such as visualization through the top and the placement of an additional device in the open center (35) in the bottom surface.

In one embodiment, the adapter-to-external ports (110) have designed to accept threaded fittings. The design of the adapter-to-external-ports can vary as needed to fit standard tubing for several external fluidic system (100), or for one particular size and type of tubing for connecting to the external fluidic system if the adapter is intended to be a semi-permanent part of the external fluidic system. The types of fittings may be dictated factors such as the need for chemical compatibility, temperature and operating pressure requirements, as well as dead-volume limitations.

FIG. 5 shows a CAD schematic of a microfluidic chip system (50) positioned above an adapter (40), wherein the adapter and microfluidic chip have corresponding ports meeting at one interface surface (48) as in FIG. 4, except the bypass channels (30) are located within the microfluidic chip (50). Of the six channels leading to the reaction area (90), four of the channels are bypass microfluidic channels (30) and one of the channels is a non-bypass microfluidic channel (70) and the other is a reaction product output channel (75). A reaction product output channel (75) allows for a reaction product to follow a single path from reaction area to a product vial in an external system in order to reduce the chance of lost material. Alternatively, the product may be collected in any suitable receptacle, or may flow into some kind of detection system for analysis, purification, and/or quality control.

Each microfluidic port (60) on the microfluidic chip surface seals against the corresponding adapter port (20). The seal may be facilitated by an O-ring (55) (FIG. 4, 5), ferrule, sheet of gasket material, or other method. Depending on the application, the sealing components may be part of the adapter (40) and/or part of the microfluidic chip (50). The O-rings (55) shown in the present disclosure are affixed to the adapter (40). However, it may be desirable to affix the O-rings to the microfluidic chip instead, to avoid the end-user losing O-rings, or in applications with short O-ring lifetime (e.g. due to harsh chemical conditions).

In one embodiment of the present disclosure, the adapter has a depression (45) that is able to receive and seal with the size of the (rigid) microfluidic chip (FIGS. 4, 5). In a preferred embodiment the depression is shallow and has a chamfered edge to facilitate insertion of the chip. It is intended that the micofluidic chip (50) and depression (45) of the adapter (40) are manufactured to close tolerances such that, when inserted, the fluid ports (20, 60) of the microfluidic chip and adapter are sufficiently well aligned. One could also imagine specialized alignment posts, holes, springs, or other mechanisms incorporated into the depression surface (45) to ensure adequate alignment. It should be taken into consideration, however, that protruding features such as posts may suffer from occasional breakage or wear, especially with frequent replacement of chips. Thus, the addition of alignment posts and such should be used with the frequency of use taken into consideration. It may be desirable to machine the depression in such a way (e.g. gentle slope) that any fluids could be cleaned up and drained easily in case of spillage into the depression.

The depression (45) could have a non-symmetric shape to provide a fool-proof mechanism to prevent incorrect installation of the chip (not shown). An asymmetrical depression shape can be achieved, for example, by adding notches or protrusions, or clipping corners of a rectangular microfluidic chip. Also, the microfluidic chip system and adapter could fit together in only one possible arrangement, such that the microfluidic chip can only have one orientation with respect to the adapter and the adapter can only have one orientation with respect to the microfluidic chip to ensure exact alignment and seal.

### Sealing Force

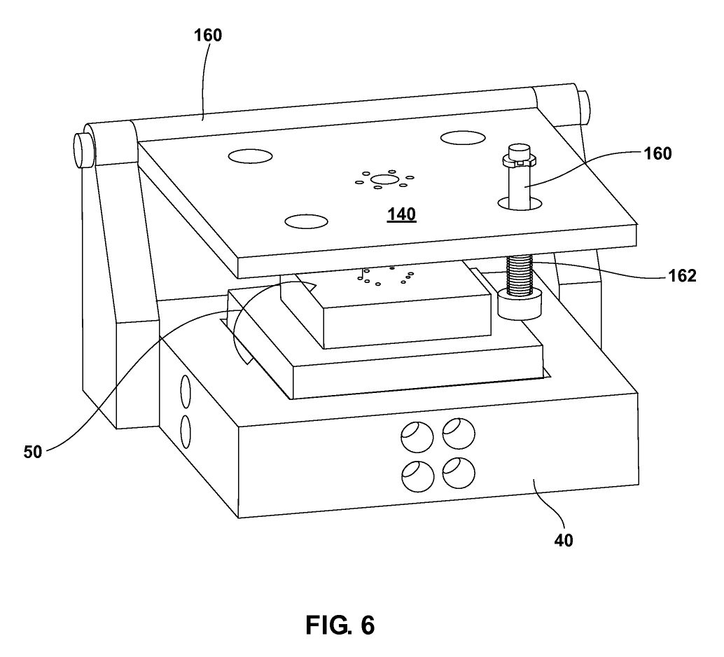

In one embodiment of the present disclosure, a force is applied to the microfluidic chip system to hold it against the O-ring or gasket layer. The force can be provided by any means known to a person skilled in the art—e.g. pneumatic or hydraulic cylinders, solenoids, springs, or a clamping or bolting mechanism. An example of a simple interface sealing force means (160) is shown in FIG. 6. A hinged top substrate (140) or plate swings down after the microfluidic chip is inserted and four spring-loaded posts (only one of the four is shown) push down on the four corners of the chip to seal it against the adapter. Once it has been lowered to maintain the force, the top plate could be latched in the correct position using a spring-loaded clip, magnets, sliding or rotating clips, etc. The sealing force could be adjusted based on fluid pressures within the microfluidic chip during operation, by selection of spring constant, or by using a spring (162) with adjustable position such as a spring plunger. Alternatively the force could be applied via pneumatic pistons or solenoids. Such methods would also allow the force to be easily adjusted and could provide signals to a control system as an interlock that prevent further chip operation unless a chip has been locked into place. One advantage of a system that applies force passively with springs is that it provides a “normally-closed” fail-safe mechanism that maintains the chip seal when the power is off.

If the microfluidic chip is made wholly or partly from flexible and/or elastic materials, the force must be applied in such a way as not to cause a distortion of the chip that interferes with its operation. For example, if the chip is made entirely from elastomeric materials, applied force can cause collapse of microchannels (van Dam, R. Michael. Solvent-Resistant Elastomeric Microfluidic Devices and Applications, PhD Thesis. California Institute of Technology, 2005). Thus, it would be preferable to apply force onto the substrate (140) immediately adjacent to the microfluidic chip—assuming the substrate is slightly larger than the chip and provided the substrate is sufficiently rigid (see FIG. 6). One could also push on regions of elastomer containing no channels, or one could make holes through the elastomer part or all of the way to the substrate to allow force to be applied to a substrate inside the perimeter of the chip.

In a “gasket” microfluidic chip as disclosed in U.S. application Ser. No. 11/701,917, the gasket is compressed between chip layers and serves as a seal, valve membrane, and gas exchange membrane. Instead of applying force to the entire surface of the rigid microfluidic chip to form an interface and seal it against the adapter, it would be desirable to press on part of the bottom layer that protrudes beyond the upper layer. In this way, the gasket compression force is not altered from its optimal state.

FIG. 6 shows a simple mechanism by which the microfluidic chip is held in place, i.e. a hinged “lid” structure. The receptacle or depression in the adapter could also be designed with spring loaded clips such that the chip locks into place as it is pushed down into the receptacle (adapter depression). A push-button or other mechanism could be used to deflect the locking part of these clips to quickly release the microfluidic chip.

In another embodiment of the present disclosure, electrical connections are incorporated into the interface for applications in which electrodes are embedded in the microfluidic chip, e.g. for the purposes of ion trapping as disclosed in U.S. Provisional Application No. 60/950,976, which is herein incorporated by reference in its entirety. Electrical connections could be as simple as metal pins/sockets/pads on the microfluidic chip with corresponding mating shapes on the adapter (possibly spring loaded to form a good electrical connection). The interface could also include other connections such as optical signals via fiber optic, mechanical switches (e.g. to detect insertion of the chip), bar code reader, flat thermal contact points, etc.

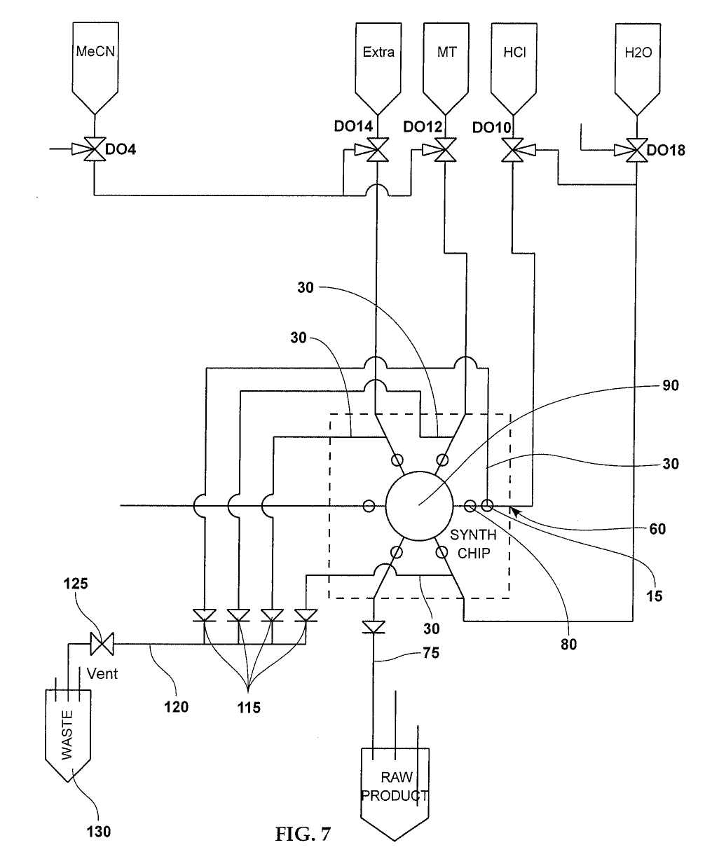

While it is possible that each reagent microfluidic channel could have its own bypass valve (125) downstream of the exit port, it is also possible to tie the exit ports together as shown in FIG. 7, thereby bleeding all air and directing all wash-solvents to a common waste (130) passing through a single bypass valve (125). To avoid cross-contamination it is necessary to include check valves (115) (simpler, less expensive) between each exit port and the common bypass valve (125). Each bypass channel would converge at each exit port into a common waste channel (120) which then travels to the bypass valve (125) before entering the common waste receptacle (130). It should be noted, however, that exit ports coming together at one common waste is not practical for reagents that must be delivered simultaneously. The check valves (115) and single bypass valve (125) could be incorporated into the interface system of the adapter and microfluidic system, or alternatively, they could be a part of the external system. Different applications and system configurations would dictate a preferred placement of these valves.

From FIGS. 1-7 it can be easily understood that the adapter (40) of the present disclosure provides a means for providing a microfluidic chip having “micro chip” size fittings and tubings, with fluid coming from an external source to remain in its typically (but not necessarily) larger-sized system. The adapter thus allows for the interfacing of two different sized systems. The adapter may have connections with the external fluidic system (100) through “non-micro” more standard sized tubing connections. “Standard” as used herein can mean various sizes, but in this case is larger (microliters to milliliters or greater) than the size tubings and volumes being used with the microfluidic chip system (nanoliters to microliters).

### Fabrication

The adapter according to the present disclosure can be made by machining or molding as is well known in the art. The fluid to be run through the interface system will dictate the types of materials which can be used. Thus the materials chosen should be compatible with the solvent and chemicals used as well as the operating temperatures and pressures. Materials to be used include, but are not limited to plastic, glass, metal and ceramic, and these materials can be assembled as one piece or multiple pieces to make the adapter. Fabrication of microfluidic chips is well known in the art (see, for example, U.S. Pat. No. 7,040,338, and U.S. application Ser. Nos. 11/297,651; 11/514,396, and 11/701,917). Materials and methods disclosed in these references would be applicable to the fabrication of the adapter as can be determined by one skilled in the art.

### Applications

The interface system and adapter as described and shown in the present disclosure has the feature that the microfluidic chip can rapidly be “snapped-in-place” with adequate alignment between fluid delivery ports on the microfluidic chip and the adapter, and adequate sealing of the microfluidic chip to the adapter. This quick-release mechanism is particularly suitable for end-user instruments requiring simple operation and where frequent exchange of disposable microfluidic chips is needed (e.g. to avoid cross-contamination of samples, to prevent degradation of microfluidic chip materials, to prevent saturation of chromatography columns or membranes, or to replace “on-chip” consumables such as tiny reagent vessels, etc.) In applications involving hazardous conditions, (e.g. radioactivity in the production of radiopharmaceuticals), it is especially desirable that the microfluidic chip can be removed and a new one inserted in a minimum time to ensure that the operator receives the lowest possible dose of radiation. It is desirable that the snap-in mechanism provides good alignment and sealing to prevent leaks or other malfunctions resulting from an incorrectly installed chip. An additional feature of the interface system and adapter (and/or microfluidic chip) is the presence of the bypass channels. These bypass channels serve to address the problem of the disparity in volumes that can be manipulated by the microfluidic device and those that are generally manipulated by external fluid handling equipment, e.g. for HPLC, automated chemistry, etc. These novel bypass channels allow tubing between the external fluidic system and the microfluidic chip to be rapidly flushed/washed to eliminate trapped air, contaminants and undesired fluid.

Advantageous applications of the disclosed interface system and adapter for the interfacing of any microfluidic chip system with an external fluidic system are numerous. Accordingly, the present invention is not limited to any particular application or use thereof. In preferred aspects, the following uses and applications for the present invention are contemplated.

The adapter system as disclosed can be used in applications including, but not limited to: biopolymer synthesis, cell sorting, DNA sorting, chemical analysis, chemical synthesis, chemical purification, radiochemical synthesis, therapeutic synthesis, optofluidics, biochemical assays, biological assays, drug discovery, pathogen detection, and semiconductor processing.

In summary, an interface system and device for interfacing a microfluidic chip system is disclosed comprising an adapter having channels and ports connecting to the microfluidic chip system and an external fluidic system. An interface, device and method are provided herein, that disclose the connection of larger volumes of an external fluidic system to smaller volumes of a microfluidic chip system and the ability to effectively purge microfluidic channels without contamination.

While illustrative embodiments have been shown and described in the above description, numerous variations and alternative embodiments will occur to those skilled in the art. Such variations and alternative embodiments are contemplated, and can be made without departing from the scope of the invention as defined in the appended claims.

1. An interface system for interfacing a microfluidic chip system with an external system comprising:
an adapter;
at least one adapter channel having two ends within said adapter, and
at least two adapter ports within said adapter, defined by a first and second opening at each end of the at least one adapter channel;
a microfluidic chip system comprising:
at least one microfluidic port;
at least one microfluidic channel, and
at least one microfluidic valve, wherein the adapter seals to the microfluidic chip system forming an interface at which the first opening of the at least two adapter ports connects to the at least one microfluidic port, and wherein the adapter is adapted to affix to the external system through connection of the second opening of the at least two adapter ports to the external system.

2. The interface system of claim 1, further comprising at least one bypass channel configured to comprise a junction point at which fluid flows toward the at least one microfluidic valve when the microfluidic valve is open and a bypass valve is closed, and fluid flows toward the at least one bypass channel when the at least one microfluidic valve is closed, and the bypass valve is open.

3. The interface system of claim 2, wherein said at least one bypass channel is located within the adapter.

4. The interface system of claim 2, wherein said at least one bypass channel is located within the microfluidic chip system.

5. The interface system of claim 2, further comprising an amount of fluid that cannot be purged through the at least one bypass channel, said interface system further comprising a configuration wherein a volume between the at least one microfluidic valve and the junction point is optimized to reduce the amount of fluid that cannot be purged.

6. The interface system of claim 2, wherein fluid is purged from the adapter and the microfluidic chip system by flowing a fixed volume of fluid in the at least one bypass channel.

7. The interface system of claim 2, further comprising one from the group of mechanical, optical and electrical means for detecting the arrival of fluid into the bypass channel.

8. The interface system of claim 2, further comprising one from the group of an O-ring, ferrule and gasket, wherein said O-ring, ferrule and gasket enhance fidelity of the interface made between the adapter and the microfluidic chip system.

9. The interface system of claim 8, wherein said O-ring, ferrule and gasket are either affixed to the adapter or to the microfluidic ship system.

10. The interface system of claim 1, wherein the at least one microfluidic chip port is more than one microfluidic chip port, and all of the more than one microfluidic chip ports are located on one surface of the microfluidic chip system.

11. The interface system of claim 1, wherein the adapter further comprises one from the group of electrical, mechanical, optical and thermal contacts which are activated upon formation of the interface.

12. The interface system of claim 1, further comprising a means for applying a force to sustain the interface of the microfluidic chip system and the adapter.

13. The interface system of claim 1, wherein the means for applying the force is provided by one selected from the group of a clamping mechanism, springs, solenoids, hydraulic cylinders, and pneumatic cylinders.

14. The interface system of claim 2, further comprising more than one bypass channel wherein each of the more than one bypass channels has a check valve upstream of a convergence into one common waste channel which then flows through one bypass valve upstream of a common waste port.

15. The interface system of claim 1, wherein the microfluidic chip system further comprises a reaction area and a reaction product output channel wherein said reaction product output channel is an only channel from the reaction area to the external system.

16. A device for interfacing a microfluidic chip system with an external system comprising:
an adapter;
at least one adapter channel located within said adapter having two ends, and
at least two adapter ports located within said adapter, defined by a first and second opening at each end of the at least one adapter channel, wherein the adapter seals to the microfluidic chip system forming an interface at which the first opening of the at least two adapter ports connects to the microfluidic chip system, and wherein the adapter is adapted to affix to the external system through connection of the second opening of the at least two adapter ports to the external system.

17. The device of claim 16, further comprising a depressed surface such that the interface of the microfluidic chip system and the adapter forms a seal between the depressed surface of the adapter and the microfluidic chip system.

18. The device of claim 17, wherein the depressed surface is non-symmetrical in shape.

19. The device of claim 17, wherein the microfluidic chip system has no more than one orientation with respect to the adapter and the adapter has no more than one orientation with respect to the microfluidic chip system.

20. The device of claim 16, further comprising an open center, wherein a heat-transfer device is inserted into the open center.

21. A method of making an interface system for interfacing a microfluidic chip system with an external fluidic system comprising:
providing an adapter having at least a first surface and a second surface;
forming at least one adapter channel having two ends within said adapter;
forming at least two adapter ports within said adapter to have a first and second opening at each end of the at least one adapter channel;
providing the microfluidic chip system comprising at least one microfluidic port;
at least one microfluidic channel, and at least one microfluidic valve;
sealing the adapter to the microfluidic chip system to form an interface;
connecting the first opening of the at least two adapter ports to the at least one microfluidic port;
affixing the adapter to the external fluidic system by connecting the second opening of the at least two adapter ports to at least one external system port.

22. The method of claim 20, wherein the adapter is fabricated by either machining or molding from a single piece or multiple pieces of one from the group of plastics, glass, metal, ceramic and combinations thereof.

23. The method of claim 20, further comprising forming at least one bypass channel within the adapter.

24. The method of claim 20, further comprising forming at least one bypass channel within the microfluidic chip system.

25. A method of making a device for interfacing a microfluidic chip system with an external system comprising:
providing an adapter having at least a first surface and a second surface;
forming at least one adapter channel having two ends within said adapter;
forming at least two adapter ports within said adapter to have a first and second opening at each end of the at least one adapter channel;
sealing the adapter to the microfluidic chip system to form an interface;
affixing the adapter to the external system by connecting the second opening of the at least two adapter ports to the external system.
